(19) United States
(12) Patent Application Publication
(10) Pub. No.: US 2025/0241485 A1
(43) Pub. Date: Jul. 31, 2025

(54) MULTI-FUNCTION GRIDDLE

(71) Applicant: CONAIR LLC, Stamford, CT (US)

(72) Inventors: Mark Sousa, Hope, RI (US); Wai Jun Ho, Boston, MA (US)

(73) Assignee: CONAIR LLC, Stamford, CT (US)

(21) Appl. No.: 18/428,617

(22) Filed: Jan. 31, 2024

(51) Int. Cl. A47J 37/07; A47J 37/06; F24C 3/08; F24C 15/28

(52) U.S. Cl. CPC A47J 37/0713; A47J 37/0682; A47J 37/0786; F24C 15/28; A47J 2037/0795; F24C 3/085

(57) ABSTRACT

A cooking device includes a frame having a plurality of legs, a main body supported by the frame and having a heating compartment having at least one burner, a cooking surface disposed above the heating compartment and configured to be heated by the at least one burner for cooking a food item in a first cooking mode, and a rack disposed below the heating compartment and configured to receive the food item thereon for cooking the food item via heat from the at least one burner in a second cooking mode.

### FIELD OF THE INVENTION

The present invention relates generally to outdoor cooking devices and, more particularly, to a multi-function, outdoor griddle operable in a variety of cooking modes.

### BACKGROUND OF THE INVENTION

As is known in the art, a barbeque grill is a device for cooking food by applying heat directly below a cooking surface that supports food items thereon. There are several types of grills, but most fall into one of two categories, either gas fueled or charcoal. Gas fueled grills typically use propane or natural gas as a fuel source, with the gas flame either cooking the food directly or heating grilling elements which in turn radiate the heat necessary to cook the food.

A griddle is a cooking device consisting of a broad, flat surface that can be heated using a variety of means and is used in both residential and commercial applications for a variety of cooking operations. The griddle is most commonly a flat metal plate of cast or wrought iron, aluminum or carbon steel. Griddles are commonly heated directly or indirectly by open flame or electrical elements. Using a griddle placed directly on a barbeque grill or over flame burners has also become popular when cooking foods not as well suited for cooking directly on a grill over an open flame. Griddles are often employed for cooking large quantities of food.

While generally well suited for what can be regarded as ordinary performance, griddles are limited in the types of cooking operations that can be carried out. In view of the above, there is a need for a multi-function griddle that is operable in a variety of cooking modes to provide a variety of different cooking functions.

### SUMMARY OF THE INVENTION

It is an object of the present invention to provide a cooking device.

It is another object of the present invention to provide a cooking device in the form of an outdoor grill or griddle.

It is another object of the present invention to provide a griddle that is operable in a variety of cooking modes to provide a variety of different cooking functions.

It is another object of the present invention to provide a griddle having a broil mode of operation.

It is another object of the present invention to provide a griddle having a damper for controlling an amount of heat provided above and below an internal heating compartment.

These and other objects are achieved by the present invention.

According to an embodiment of the present invention, a cooking device includes a frame having a plurality of legs, a main body supported by the frame and having a heating compartment having at least one burner, a cooking surface disposed above the heating compartment and configured to be heated by the at least one burner for cooking a food item in a first cooking mode, and a rack disposed below the heating compartment and configured to receive the food item thereon for cooking the food item via heat from the at least one burner in a second cooking mode.

According to yet another embodiment of the present invention, a multi-function grill includes a support structure having a plurality of legs, a main body supported by the support structure, the main body defining a heating compartment, a cooking surface disposed above the heating compartment and configured to be heated by the heating compartment, and a rack disposed below the heating compartment and configured to receive a food item thereon for cooking the food item via heat from the heating compartment.

According to yet another embodiment of the present invention, a method of operating a cooking appliance includes the steps of heating an internal heating compartment, and adjusting a damper within the internal heating compartment to vary an amount of heat provided to a cooking surface located above the internal heating compartment, and an amount of heat provided to a rack located below the internal heating compartment.

### BRIEF DESCRIPTION OF THE DRAWINGS

The present invention will be better understood from reading the following description of non-limiting embodiments, with reference to the attached drawings, wherein below:

FIG. 1 is a perspective view of a griddle according to an embodiment of the present invention, showing a cover thereof in a closed position.

FIG. 2 is a perspective view of the griddle of claim 1, showing the cover thereof in an open positions.

FIG. 3 is a side elevational view of the griddle of claim 1.

FIG. 4 is a top plan view of the griddle of claim 1.

FIG. 5 is an enlarged, rear perspective view of a portion of the griddle of FIG. 1.

FIG. 6 is a top, perspective view of a heating chamber of the griddle of FIG. 1, showing heat deflectors in an open position.

FIG. 7 is another top, perspective view of the heating chamber of the griddle of FIG. 1, showing the heat dampers in the open position.

FIG. 8 is an underside, perspective view of the heating chamber of the griddle of FIG. 1, showing the heat dampers in the open position.

FIG. 9 is a cross-sectional, perspective view of the heating chamber of the griddle of FIG. 1, showing the heat dampers in the open position.

FIG. 10 is a perspective view of a burner of the griddle of FIG. 1.

FIG. 11 is a top, perspective view of a heating chamber of the griddle of FIG. 1, showing the heat dampers in a closed position.

FIG. 12 is another top, perspective view of the heating chamber of the griddle of FIG. 1, showing the heat dampers in the closed position.

FIG. 13 is an underside, perspective view of the heating chamber of the griddle of FIG. 1, showing the heat dampers in the closed position.

FIG. 14 is a cross-sectional, perspective view of the heating chamber of the griddle of FIG. 1, showing the heat dampers in the closed position.

FIG. 15 is a bottom, perspective view showing a reflector plate on an underside surface of the griddle plate.

FIG. 16 is a side, elevational view showing the reflector plate on the underside surface of the griddle plate.

FIG. 17 illustrates various multi-function cooking devices according to embodiments of the present invention.

### DETAILED DESCRIPTION OF THE PREFERRED EMBODIMENT

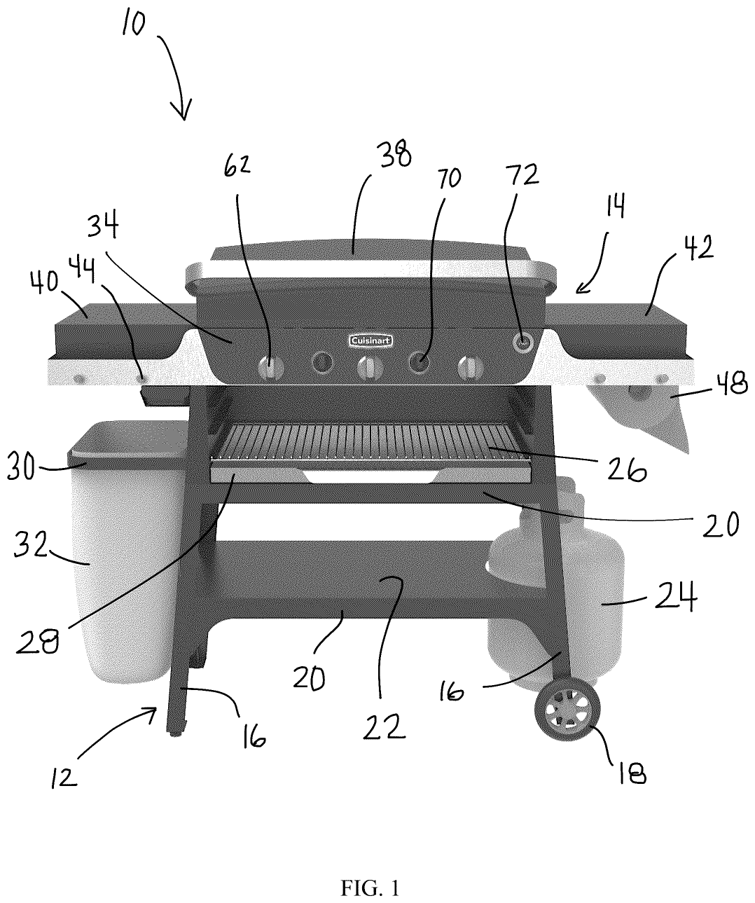

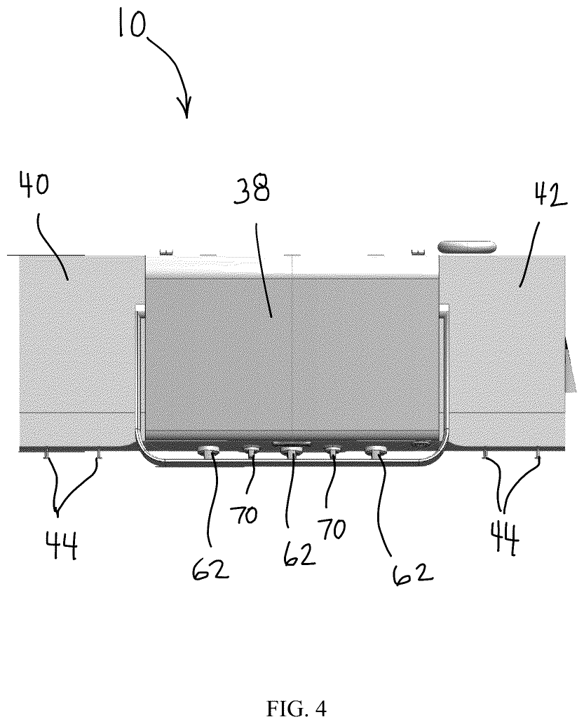

With reference to FIGS. 1-5, a multi-function cooking device 10 in the form of an outdoor griddle is illustrated. As shown therein, the cooking device 10 includes a support structure or frame 12 and a main body 14 supported by the frame 12. In an embodiment, the frame includes a plurality of legs 16, e.g., four legs, one or more of which may be outfitted with a wheel 18 or caster facilitating movement of the cooking device 10. In an embodiment, the legs 16 may include adjustable feet enabling for leveling of the cooking device, as needed. In some embodiments, the frame 12 may include doors or drawers to provide cabinet like characteristics in the cooking device 10. The frame 12 may also include one or more cross-members 20 extending between the legs 16 for stability of the cooking device 10. Further, a lower portion of the frame may include a panel or shelf 22 for stowing various items such as grill brushes and the like. Further, the lower portion of the frame 12 may include a supporting structure for supporting a propane tank 24, for example.

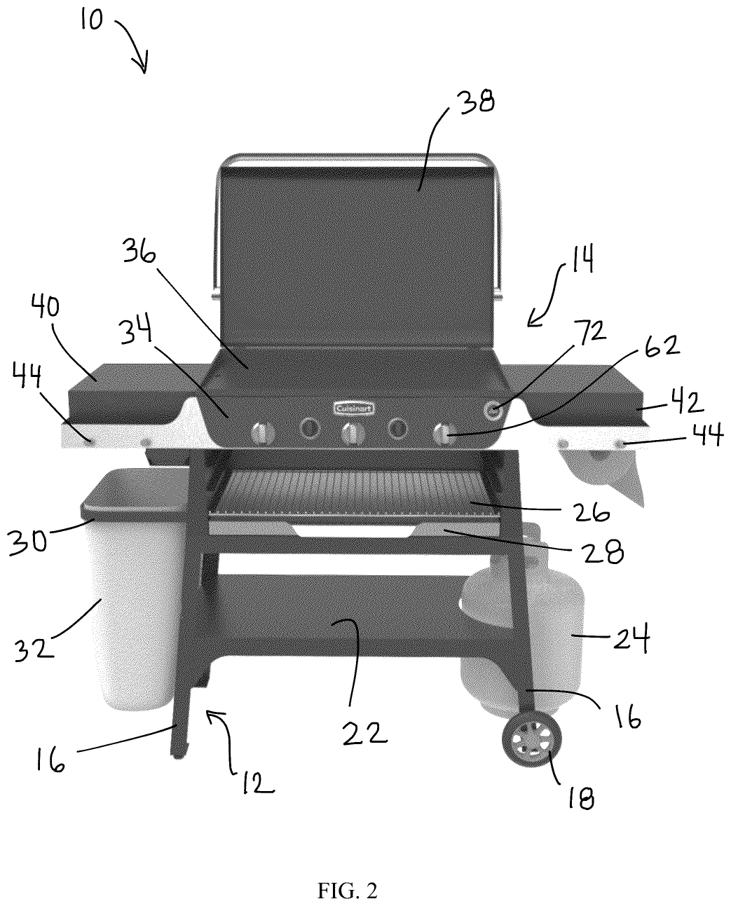

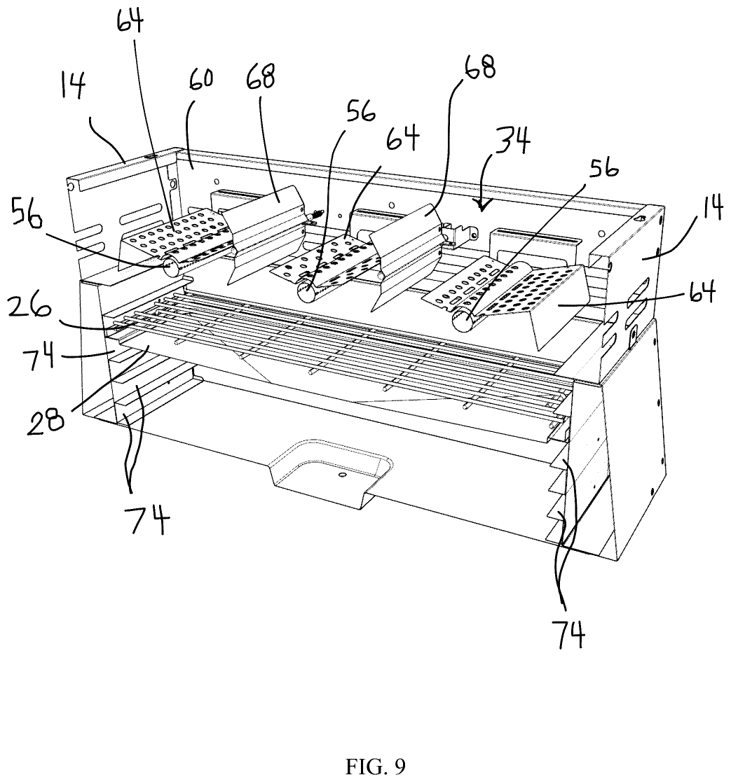

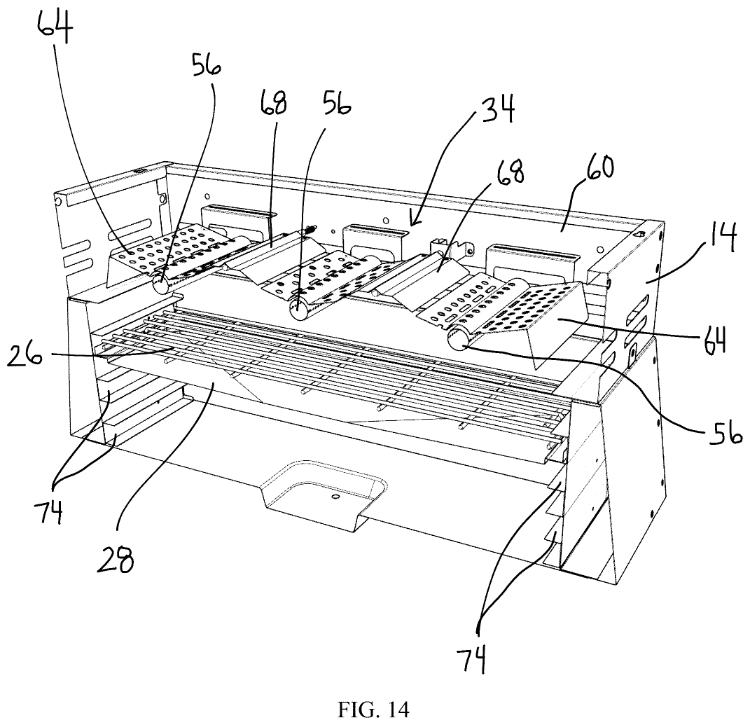

As best illustrated in FIGS. 1 and 2, the cooking device 10 further includes a wire grill rack 26 for supporting food items, as discussed below, as well as a reflector plate 28, both supported by the frame 12. In an embodiment, the wire grill rack and reflector plate 28 are slidably removable from the front of the frame 12 for cleaning and/or access to food items or drippings. In an embodiment, the rack 26 and reflector plate 28 are integrated as a single unit, although it is contemplated that these may be separate components. While a wire grill rack 26 is illustrated, in other embodiments, the rack 26 may take any configuration such as a solid surface or the like. The rack 26 and/or reflector plate 28 may be supported on tracks or in slots on opposing sides of the frame (as best shown in FIGS. 9 and 14), although other mounting arrangements are also possible without departing from the broader aspects of the invention. In an embodiment, the frame 12 may additionally include rail 30 or other support mechanism for supporting and retaining a trash receptacle 32.

With further reference to FIGS. 1-5, the main body 14 is generally rectangular in shape and defines a heating chamber 34, atop which is positioned a griddle 36 formed as a flat cooking surface formed from metal such as rolled carbon steel, although other materials known in the art may also be utilized. In other embodiments, however, the griddle 36 may instead be a grill grate. In one embodiment, the cooking device 10 may include a hood or cover 38 moveable to various positions relative to the griddle 36. In an embodiment, the hood 38 is pivotably coupled to the cooking device 10 such that the hood 38 may pivot or rotate between a closed position (shown, for example, in FIG. 1) and a fully open position (shown, for example, in FIG. 2), as well as various other open positions tilted or pivoted forward relative to the fully open position. In a further embodiment, such hood 38 may be pivotably coupled to the griddle 36. Further, the hood 38 may be removable from the griddle 36 or cooking device 10.

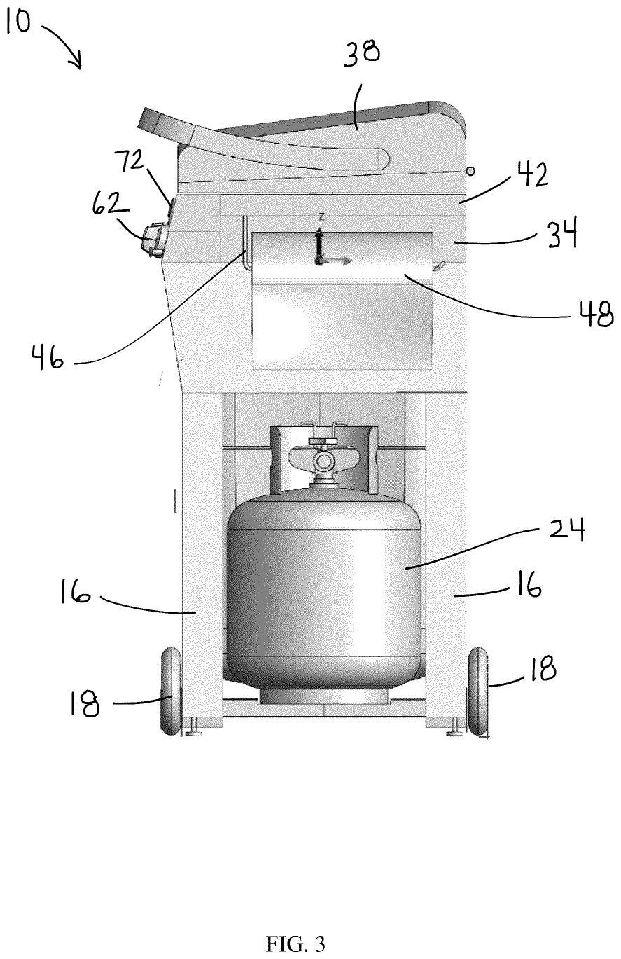

As additionally shown in FIGS. 1-5, the cooking device 10 the main body 14 of the cooking device 10 may include a first side shelf 40 and a second side shelf 42. The first and second side shelves 40, 42 may be coupled to respective first and second sides of the main body. In some embodiments, the first and second side shelves 40,42 may be substantially level with the upper end of the main body 18. In other embodiments, the first and second side shelves 40, 42 may be positioned lower than level with the upper end of the main body 18. One or both of the first and second side shelves 40, 42 may include various hooks 44 for hanging utensils and the like. As best shown in FIG. 3 one of the shelves, e.g., the second side shelf 42 may include a bar 46 depending from the underside thereof for holding a roll of paper towels 48.

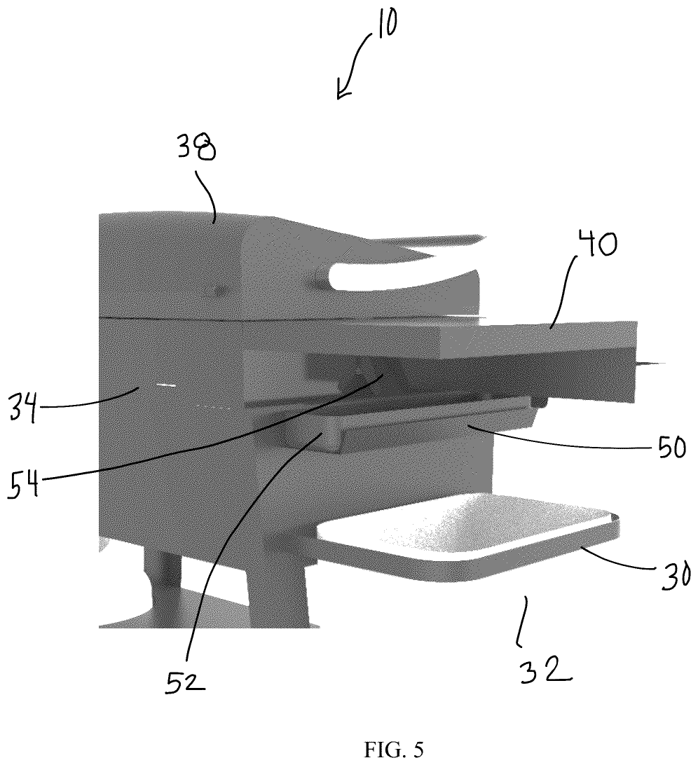

With particular reference to FIG. 5, the underside of the left side shelf 40 or the left side of the main body 18 may include a bracket 50 for receiving a grease tray 52. As also shown therein, the left side of the main body 18 includes a trough 54 that forms a passageway to the upper surface of the griddle 36. The trough 54 is utilized to direct grease, drippings and food remnants into the grease tray 52 for disposal.

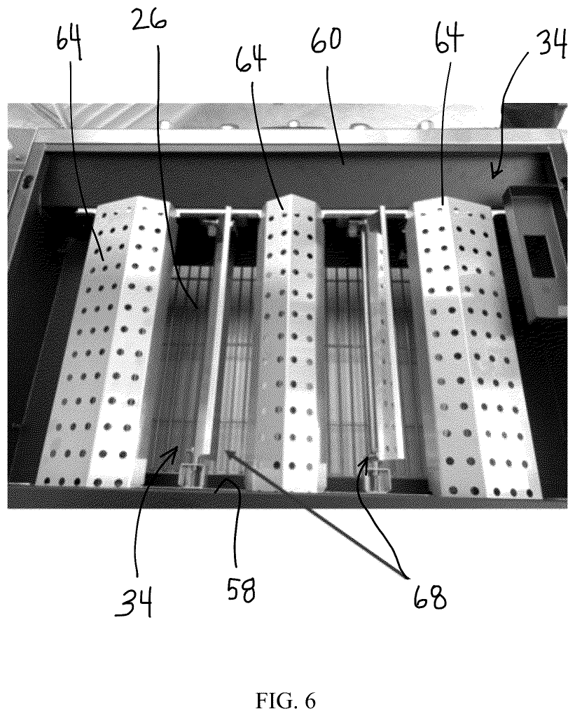

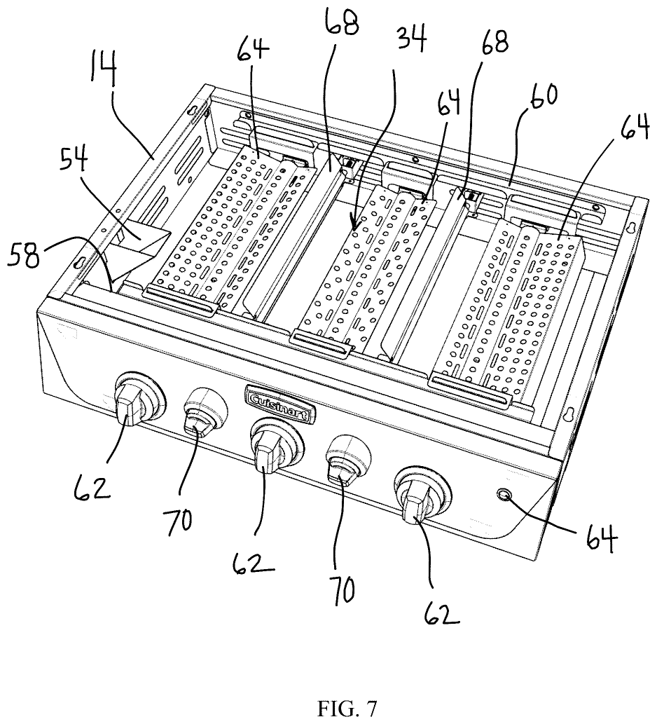

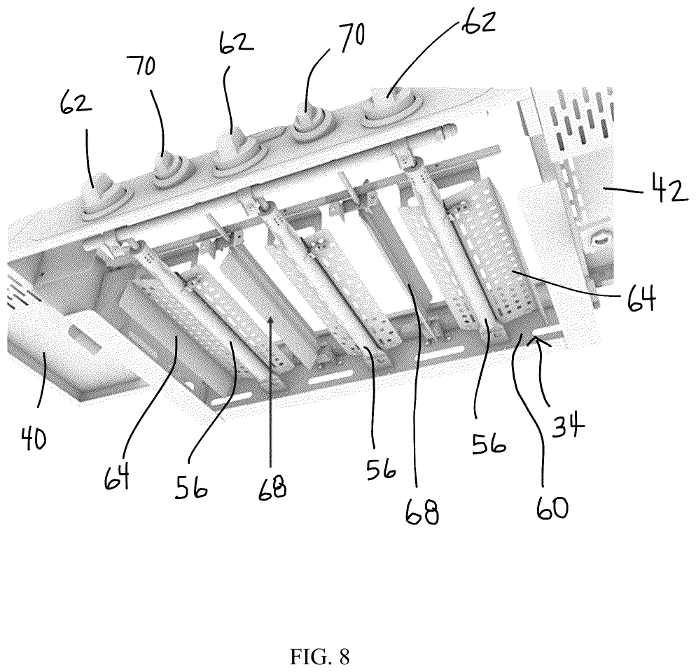

Referring now to FIGS. 6-9, the configuration of the heating compartment 34 of the main body 14 beneath the griddle 36 is best illustrated. As shown therein, the heating compartment 34 includes one or more heating elements, such as gas burners 56, extending between a front panel 58 and a rear panel 60 of the heating compartment 34. The front panel 38 includes various components and controls positioned and secured therewith such that burner knobs 62 may be positioned along an exterior side of the front panel 58 for controlling an intensity of the flame emitted by the associated burner 56. The gas burners 56 may receive fuel by rotating the burner knobs 62 from an off-position to an on-position. Such burner knobs 62 may be coupled to the front panel 58 of the heating chamber 34 and may each be aligned with a corresponding gas burner 56. Each of the burner knobs 62 may include the appropriate valves and components associated therewith configured to control gas being supplied to the gas burners 56, as known in the art. In an embodiment, there are three burners 56 and three dedicated control knobs 62, although fewer than three or more than three burners and/or knobs may be utilized depending on grill size, heating capacity, etc.

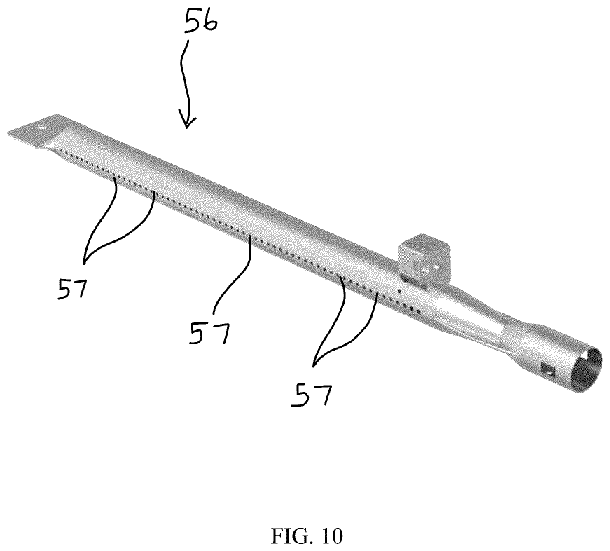

As illustrated in FIG. 10, a burner 56 according to an embodiment of the present invention is illustrated. As shown therein, the burners 56 are generally tubular in shape and include a plurality of holes 57 on the left and right sides thereof (as opposed to the top and bottom). In an embodiment, the burners 56 are 15,000 BTU gas burners. In use, gas supplied to the burners 56 exits the holes and is ignited to produce a steady flame. It is contemplated, however, that other types of gas burners known in the art may also be utilized without departing from the broader aspects of the invention.

Turning once again to FIGS. 6-9, the interior heating compartment 34 includes a plurality of burner shields 64 (also referred to as flame tamers, diffusers and/or heat deflectors) that likewise extend between the front wall 58 and rear wall 60 of the heating compartment 34. As illustrated therein, the burner shields 64 are angled members that extend over and effectively cover the burners 56. In an embodiment, the burner shields 64 include a plurality of perforations, apertures or slots distributed throughout the burner shields 64 that allow heat generated by the burners 56 to rise upwardly to the underside of the griddle plate 36 to heat the griddle plate 36.

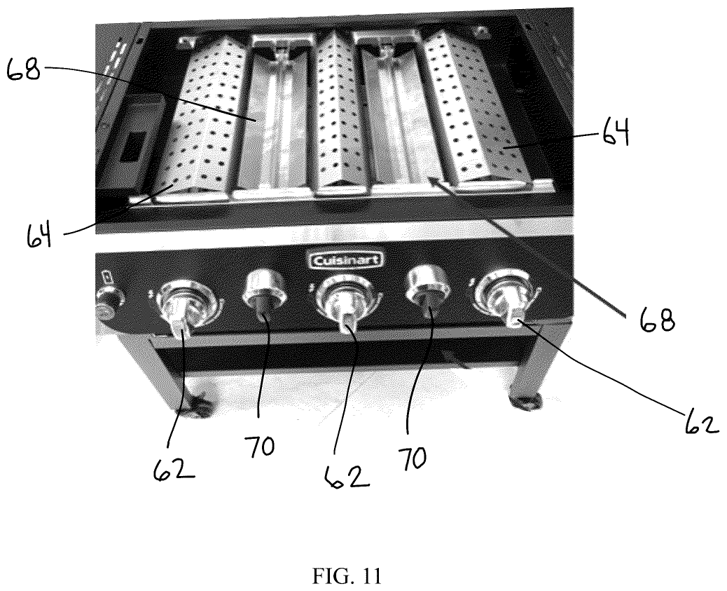

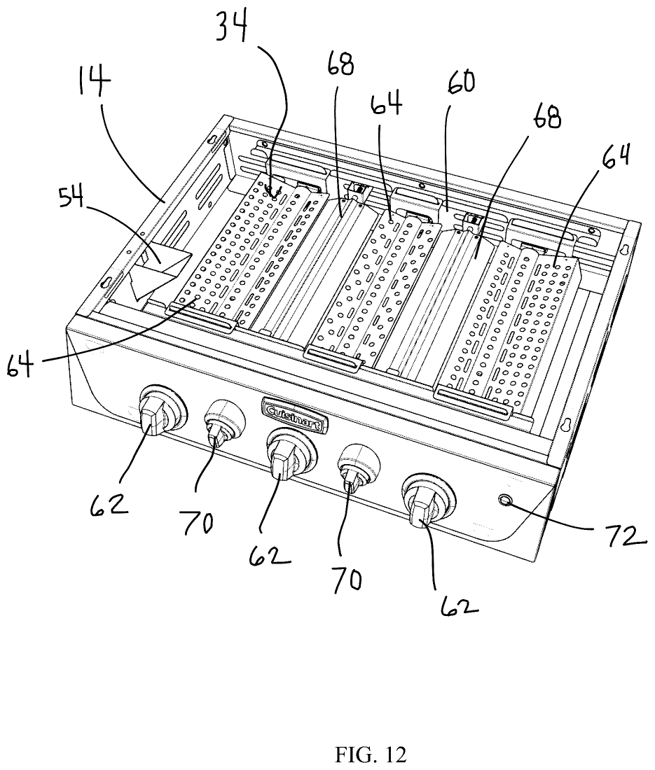

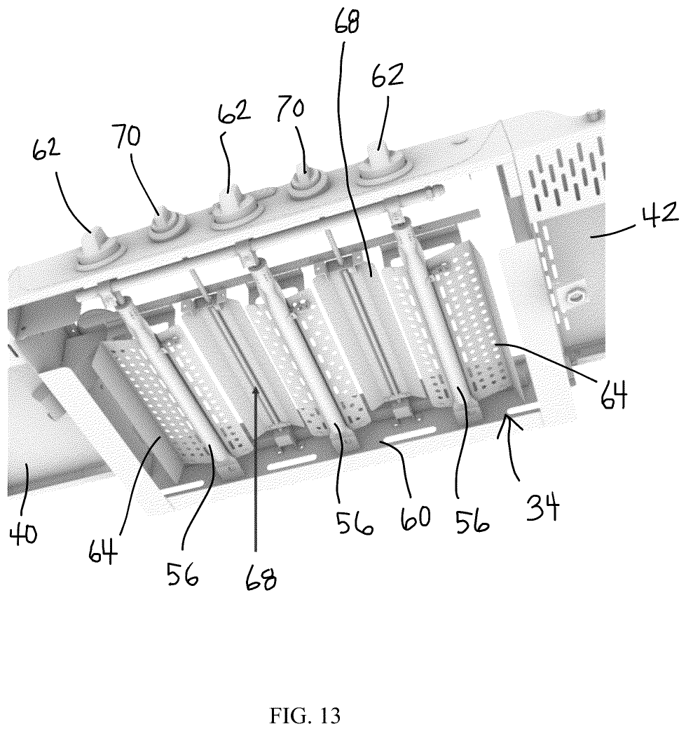

With further reference to FIGS. 6-9, the heating compartment 34 additionally includes a plurality of rotatable dampers or deflectors 68 that extend between the front wall 58 and rear wall 60. As shown there, the dampers 68 are positioned intermediate the burner shields 64. Each damper 68 is mounted to an associated control knob 70 on the exterior side of the front panel 58 for controlling the position of the respective dampers 68. For example, control knobs 70 can be utilized to move the dampers 68 between an open position (shown in FIGS. 6-9) and a closed position (shown in FIGS. 11-14), or any position in between. In an embodiment, the dampers 68 are generally flat plates, and in some embodiments, may have generally concave curvature when viewed from below when the dampers 68 are in the closed position. Operation of the dampers will be described in detail hereinafter.

The main body 14 also includes an igniter switch 72. The igniter switch 72 may be positioned on the front panel 58 sized and configured to ignite the particular gas burners 56 corresponding with any one of the given burner knobs 62 rotated to the on-position. In an embodiment, the igniter switch 72 is a piezo igniter, although other igniter types known in the art may be utilized without departing from the broader aspects of the invention. While the igniter switch 72 is shown as a standalone igniter switch, it is contemplated that an igniter switch may be integrated with each burner knob 62, instead. The gas burners 56 may be fueled with gas, such as propane gas from propane gas tank 24, or fueled with natural gas, which may be coupled to the gas burners 56 via various components, such as a gas line and connection valve or the like. Although only some of the primary components for operating the cooking device 10 are described herein, the remaining components that may be needed for proper functioning of the cooking station may be incorporated herewith and into the cooking device 10 as known by one of ordinary skill in the art.

FIGS. 9 and 14 best illustrate the location of the burners 56, burner shields 64 and dampers 68 in relation to the wire rack 26. As shown therein, and as alluded to above, opposing sides of frame (or heating compartment 34) include a plurality of vertically spaced slots or tracks 74 allowing the wire rack 26 to be selectively placed closer to, or further away from, the burners 56, as desired.

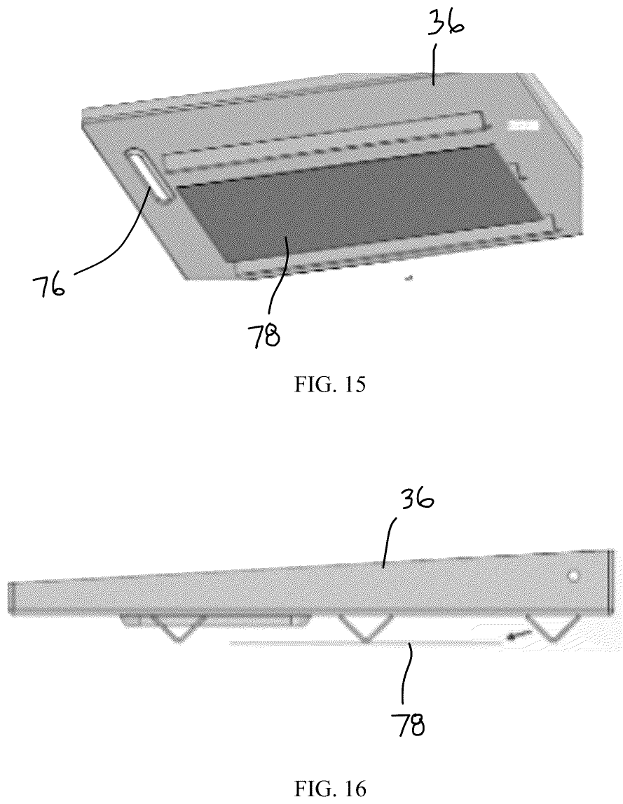

With reference to FIGS. 15 and 16, the griddle 36 includes a through aperture 76 in communication with the grease trough 54 when the griddle 36 is placed atop the heating compartment 34 of the main body 14. As also shown therein, the griddle 36 includes a second reflector plate 78 mounted to an underside thereof, the purpose which will be described hereinafter. In an embodiment, the reflector plates 28, 78 may be formed from metal and may have a surface finish that reflects heat from burners 56.

Referring back to FIGS. 6-9, in operation, the cooking device 10 can be utilized to cook food items placed on the griddle 36. In a griddle mode, dampers 68 can be rotated to their closed position as shown therein using the control knobs 70. In this position, the dampers 68 are oriented generally horizontally, so that the dampers 68, and the edges thereof, are disposed at a position generally above a plane in which the burners 56 are positioned. One or more of the burners 56 can then be ignited using knobs 62 and igniter 72. In the open position of the dampers 68, the heat from the burners 56 is permitted to pass by the dampers 68, as well as through the apertures in the burner shields 64. Heat from the burners 56 heats the griddle 36 from below, causing the cooking surface thereof to rise to a temperature suitable to cook food items placed thereon. The burner knobs 62 can be utilized to control the intensity of the burners 56, and thus the temperature of the griddle 36.

The cooking device 10 of the present invention is also operable in a broil mode, using the wire rack 26 positioned beneath the heating compartment 14 and burners 56. For example, in a broil mode of operation, food items are placed on the rack 26. The damper control knobs 70 can then be utilized to rotate one or more of the dampers 68 to their closed positions, as shown in FIGS. 11-14. In this position, the dampers 68 obstruct the space intermediate the burner shields 64 causing more heat from the burners 56 to be deflected downwardly toward the rack 26 to cook the food items supported thereon. The reflector plate 28 beneath the rack 26, and the reflector plate 78 on the underside of the griddle 36 also function to direct heat towards the wire rack 26 and the food items thereon.

Importantly, the intensity of heat provided to the food items on the wire rack 26 can be controlled in a number of way. First, the intensity of the flame can be adjusted using burner control knobs 62. Second, the dampers 68 can be adjusted to a position whereby maximum heat is reflected down toward the food items (the closed position of the dampers 68), or minimum heat is reflected down towards the food items (the open position of the dampers 68), or an intermediate position. Third, the vertical position of the rack 26 in relation to the burners 56 and dampers 68 can be adjusted depending on which track 74 the wire rack 26 is positioned in. These different mechanisms provide a level of control over cooking heretofore not seen in the art.

The adjustable dampers 68 also allow the intensity of heat traveling upwardly, and thus the temperature of the griddle 36 (or grill surface, as the case may be) to be more precisely controlled. For example, the dampers 68 can be used to prevent the upwardly rising flames from being too concentrated on the griddle/grilling surface above the flames by closing the dampers 68 and deflecting the heat downwardly. In addition to the above, certain dampers 68 can be moved to an open or closed position, while other of the dampers are moved to the opposite position to provide additional control and flexibility over the cooking of food items.

The present invention thus adds to a typical grill or griddle a “broil” mode in which you food to be cooked can be positioned beneath the flame output source. The cooking device 10 employs adjustable deflectors 68 to direct the heat downwardly to broil the food positioned below. As will be readily appreciated, the cooking device 10 can thus be utilized to cook a first food items on the upper griddle/grill in a first cooking mode (e.g., frying/direct contact grilling), and to simultaneously cook a second food item on the broil rack 26 in a second cooking mode (broiling). Alternatively, direct contact cooking of a food item can be carried out first using the upper griddle/grill, and then the food item can be finished by moving it to the broil rack 26 and carrying out a broiling function in the manner described above. Alternatively, broiling can be carried out first, and direct contact cooking carried out thereafter.

While the cooking device 10 has been described as being of the type that is gas heated with propane (e.g., from propane tank 16) or natural gas, the present invention is not intended to be so limited in this regard. In particular, the cooking device 10 may also be employed with alternative fuel sources, such as charcoal, wood chips or any other suitable fuel source.

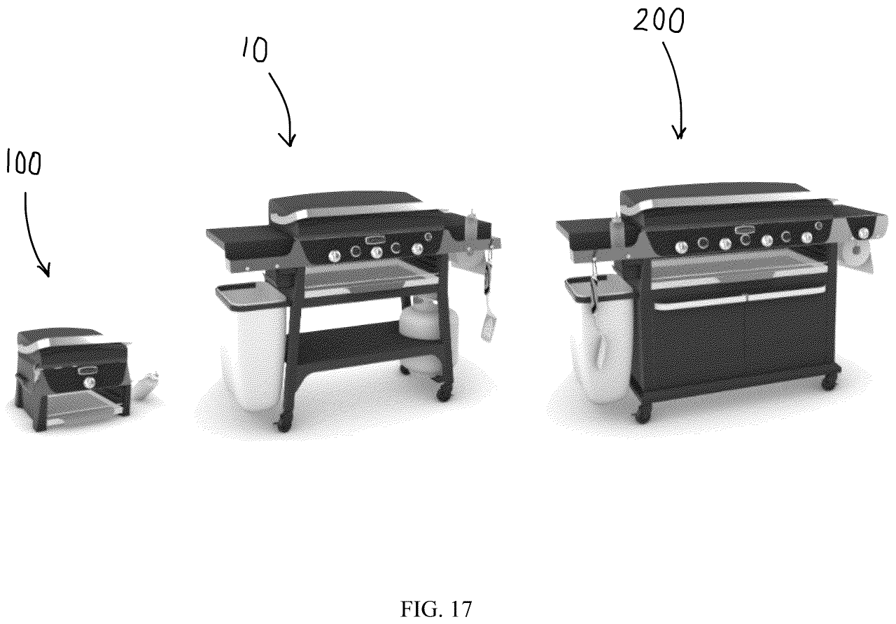

Turning finally to FIG. 17, the grilling/broiling configuration and functionality disclosed above can be integrated into a variety of different sized devices. For example, FIG. 17 shows cooking device 10, with four burners and two dampers/deflectors, a cooking device 100 with a single burner and damper, and a cooking device 200 with four burners and three dampers.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A cooking device, comprising:
a frame having a plurality of legs;
a main body supported by the frame and having a heating compartment having at least one burner;
a cooking surface disposed above the heating compartment and configured to be heated by the at least one burner for cooking a food item in a first cooking mode; and
a rack disposed below the heating compartment and configured to receive the food item thereon for cooking the food item via heat from the at least one burner in a second cooking mode.

2. The cooking device of claim 1, wherein:
the cooking surface is one of a griddle and a grill grate.

3. The cooking device of claim 1, wherein:
the rack includes a wire rack and a reflector plate disposed below the wire rack.

4. The cooking device of claim 1, wherein:
a vertical position of the rack in relation to the at least one burner is adjustable.

5. The cooking device of claim 4, further comprising:
a plurality of vertically spaced tracks configured to receive the rack in various vertically spaced positions in relation to the at least one burner.

6. The cooking device of claim 1, further comprising:
at least one damper within the heating compartment, the at least one damper being selectively adjustable between an open position and a closed position to control an amount of heat provided to the cooking surface and/or the rack.

7. The cooking device of claim 1, further comprising:
a damper control knob connected to the at least one damper for adjusting a position of the at least one damper.

8. The cooking device of claim 7, wherein:
the at least one damper is a plurality of dampers each having an associated damper control knob.

9. The cooking device of claim 1, further comprising:
a reflector plate positioned on an underside of the cooking surface.

10. The cooking device of claim 1, further comprising:
a reflector plate positioned beneath the rack.

11. The cooking device of claim 6, further comprising:
a burner shield disposed over the at least one burner, the burner shield having a plurality of apertures.

12. A multi-function grill, comprising:
a support structure having a plurality of legs;
a main body supported by the support structure, the main body defining a heating compartment;
a cooking surface disposed above the heating compartment and configured to be heated by the heating compartment; and
a rack disposed below the heating compartment and configured to receive a food item thereon for cooking the food item via heat from the heating compartment.

13. The multi-function grill of claim 12, wherein:
the cooking surface is a griddle.

14. The multi-function grill of claim 12, further comprising:
at least one heating element within the internal heating compartment.

15. The multi-function grill of claim 14, wherein:
the at least one heating element is a gas burner.

16. The multi-function grill of claim 14, wherein:
a vertical position of the rack in relation to the at least one heating element is adjustable.

17. The multi-function grill of claim 12, further comprising:
at least one damper within the heating compartment, the at least one damper being selectively adjustable between an open position and a closed position to control an amount of heat provided to the cooking surface and/or the rack.

18. The multi-function grill of claim 17, further comprising:
a damper control knob connected to the at least one damper for adjusting a position of the at least one damper.

19. A method of operating a cooking appliance, comprising the steps of:
heating an internal heating compartment; and
adjusting a damper within the internal heating compartment to vary an amount of heat provided to a cooking surface located above the internal heating compartment and an amount of heat provided to a rack located below the internal heating compartment.

20. The method according to claim 19, further comprising the step of:
adjusting a vertical position of the rack in relation to the internal heating compartment.
